(19) United States
(12) Patent Application Publication
(10) Pub. No.: US 2024/0319461 A1
(43) Pub. Date: Sep. 26, 2024

(54) OPTICAL FIBER RIBBON PRINT SPACING FOR REDUCED TRANSMISSION LOSS

(71) Applicant: OFS Fitel, LLC, Norcross, GA (US)

(72) Inventors: Eric T Joyce, Carrollton, GA (US); Kariofilis Konstadinidis, Decatur, GA (US); Heng Ly, Stone Mountain, GA (US); David W Peckham, Lawrenceville, GA (US); Kenji Yokomizo, Douglasville, GA (US)

(73) Assignee: OFS Fitel, LLC, Norcross, GA (US)

(21) Appl. No.: 18/124,701

(22) Filed: Mar. 22, 2023

(51) Int. Cl. G02B 6/44

(52) U.S. Cl. CPC G02B 6/4403

(57) ABSTRACT

Embodiments of the invention include an optical fiber ribbon. The optical fiber ribbon includes a plurality of optical fibers arranged adjacent to one another in a linear array. The optical fiber ribbon also includes a bonding matrix material applied to at least a portion of the outer surface of at least two adjacent optical fibers. The optical fiber ribbon also includes at least one marking applied to the outer surface of at least one optical fiber. The at least one marking is applied to the outer surface of at least one optical fiber in a manner that reduces the optical transmission loss of the optical fibers.

### BACKGROUND OF THE INVENTION

### Field of Invention

The invention relates to optical fiber ribbons, such as optical fiber rollable ribbons. More particularly, the invention relates to print markings applied to optical fiber ribbons, including optical fiber rollable ribbons.

### Description of Related Art

As the demand for data transmission has increased, the demand for having more optical fibers in a given optical fiber cable also has increased. Such demand has resulted in up to 6,912 optical fibers (e.g., 576 optical fiber ribbons having 12 fibers per optical fiber ribbon) currently being packed in a single optical fiber cable. With this many optical fibers being packed in the same optical fiber cable, it has become relatively difficult to distinguish individual optical fiber ribbons from one another within the same optical fiber cable.

One way to identify individual optical fiber ribbons within the same optical fiber cable is by applying (e.g., printing) some sort of marking ink or other suitable material on the surface of one or more optical fibers of each optical fiber ribbon within the optical fiber cable. Each marking ink or other suitable material is unique to each optical fiber ribbon within the optical fiber cable and thus allows each optical fiber ribbon to be uniquely identified compared to other optical fiber ribbons within the optical fiber cable.

However, the application of marking ink or other suitable material on the surface of optical fibers can ultimately affect the transmission performance of the optical fibers, as optical fiber transmission loss of a given optical fiber can be relatively sensitive to the marking ink or other suitable material applied to the surface of the respective optical fiber. This is especially true for optical fibers that are part of a rollable or flexible optical fiber ribbon, i.e., an optical fiber ribbon having intermittent matrix bonding material along the length of the optical fiber ribbon. Many current optical fiber cables employ rollable or flexible optical fiber ribbons to achieve a greater packing density within the optical fiber cable.

### SUMMARY OF THE INVENTION

The invention is embodied in an optical fiber ribbon. The optical fiber ribbon includes a plurality of optical fibers arranged adjacent to one another in a linear array. The optical fiber ribbon also includes a bonding matrix material applied to at least a portion of the outer surface of at least two adjacent optical fibers. The optical fiber ribbon also includes at least one marking applied to the outer surface of at least one optical fiber. The at least one marking is applied to the outer surface of at least one optical fiber in a manner that reduces the optical transmission loss of the optical fibers.

### BRIEF DESCRIPTION OF THE DRAWINGS

FIG. 1 is a cross-sectional view of a conventional optical fiber;

FIG. 2A is a perspective view of an optical fiber ribbon having marking ink printed thereon for identification, according to embodiments of the invention;

FIG. 2B is a top view of several optical fibers in an optical fiber ribbon having marking ink printed thereon, showing the marking ink as a series of rows of print dots having a pitch between adjacent print dots in each row, according to embodiments of the invention;

FIG. 2C is an expanded top view of several optical fibers in the optical fiber ribbon of FIG. 2B, showing the marking ink as a series of rows of print dots having a pitch between adjacent print dots in each row, according to embodiments of the invention;

FIG. 3 is a graph of the added optical transmission loss of an optical fiber operating at an optical transmission rate of 1550 nanometers (nm) for different pitches between adjacent print dots, according to embodiments of the invention; and

FIG. 4 is a graph of the added optical transmission loss of an optical fiber operating at an optical transmission rate of 1310 nanometers (nm) for different pitches between adjacent print dots, according to embodiments of the invention.

### DETAILED DESCRIPTION OF EXEMPLARY EMBODIMENTS

In the following description like reference numerals indicate like components to enhance the understanding of the invention through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the invention.

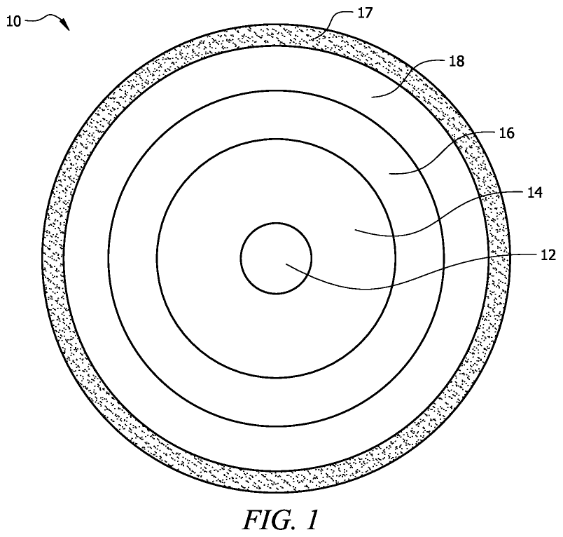

FIG. 1 is a cross-sectional view of a conventional optical fiber 10. The optical fiber 10 includes a core portion 12, a cladding portion 14 surrounding the core portion 12, and one or more coating portions surrounding the cladding portion 14, e.g., a primary coating portion 16 surrounding the cladding portion 14, and a secondary coating portion 18 surrounding the primary coating portion 16.

The core portion 12 and the cladding portion 14 are made of glass. The coating portions 16, 18, which are made of plastic or an ultraviolet (UV) curable acrylate material, protects the core portion 12 and the cladding portion 14 from breaking. The secondary coating portion 18 can be a particular color to distinguish the optical fiber 10 from other optical fibers, e.g., within the same optical fiber ribbon, Alternatively, the optical fiber 10 can include a color layer 17 surrounding the secondary coating portion 18, e.g., to distinguish the optical fiber 10 from other optical fibers, e.g., within the same optical fiber ribbon.

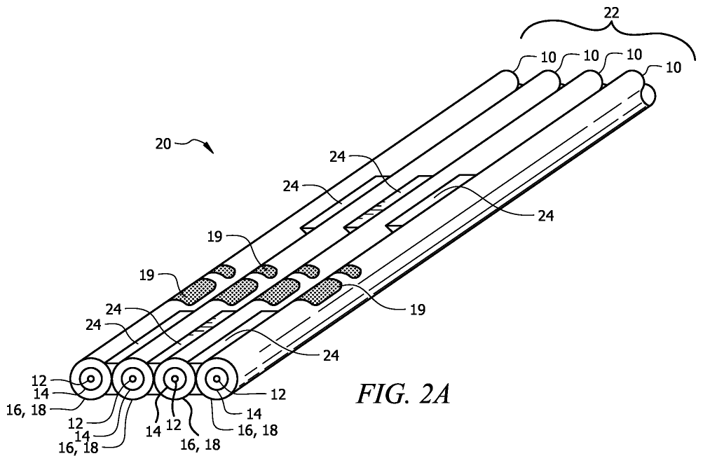

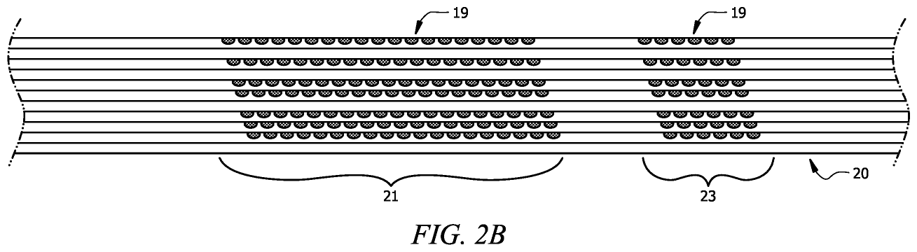

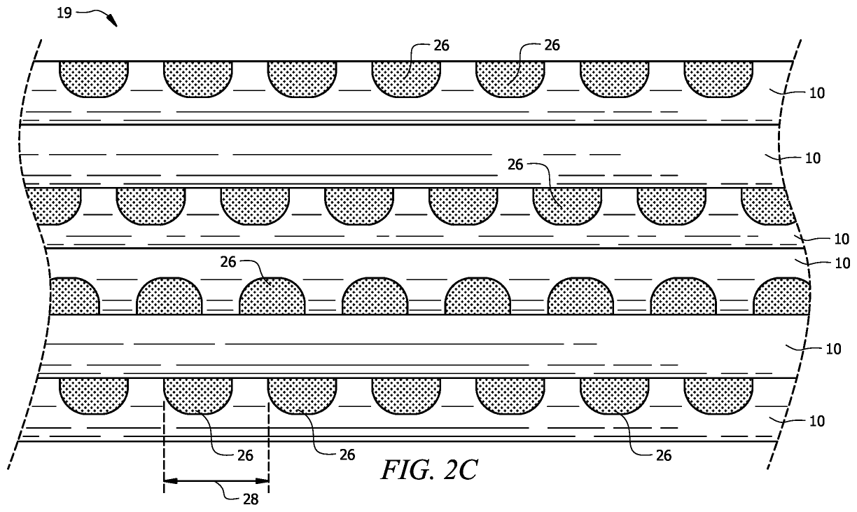

FIG. 2A is a perspective view of an optical fiber ribbon 20 having an array 22 of optical fibers 10 arranged adjacent to one another and bonded together with a matrix material or a bonding matrix material to form the optical fiber ribbon 20. Optical fiber ribbons typically have between 4 and 24 optical fibers, usually either 12 or 24 optical fibers per ribbon.

Each optical fiber 10 has a core portion 12, a cladding portion 14 formed around the core portion 12, and one or more coating portions 16, 18 surrounding the cladding portion 14. In this optical fiber ribbon 20, the periphery of the optical fibers 10 are intermittently covered with a ribbon matrix portion 24. It should be understood that in some optical fiber ribbons, the periphery of the optical fibers are completely covered with the ribbon matrix portion.

An optical fiber cable may include a plurality of optical fiber ribbons 20. To uniquely classify and/or identify optical fiber ribbons from one another, markings often are printed on or otherwise applied to optical fiber ribbons, i.e., to the outer surface of one or more of the optical fibers 10 of the optical fiber ribbon 20. These markings can be any suitable indicia that uniquely identifies the optical fiber ribbon from other optical fiber ribbons. For example, as shown in FIG. 2A, several of the optical fibers 10 have marking ink or other suitable indicia 19 printed thereon for the purpose of identifying the optical fiber ribbon 20 from other optical fiber ribbons (not shown).

As an example, the marking ink or other suitable indicia 19 printed on one or more of the optical fibers 10 of the optical fiber ribbon 20 can be in the form of one or more relatively wide bands and/or one or more narrower bands, with each wide band representing the number five and each narrower band representing the number one. In this manner, as shown, an optical fiber ribbon 20 designated as optical fiber ribbon “6” would have marking ink or other suitable indicia 19 printed on the optical fibers 10 in the form of one wide band (1×5=5) and one narrower band (1×1=1) (5+1=“6”). Similarly, an optical fiber ribbon 20 designated as optical fiber ribbon “33” (not shown) would have marking ink or other suitable indicia 19 printed on the optical fibers 10 in the form of six wide bands (6×5=30) and three narrower bands (3×1=3) (30+3=“33”).

FIG. 2B is a top view of several optical fibers 10 in an optical fiber ribbon 20 having marking ink or other suitable indicia 19 printed thereon or otherwise applied thereto, according to embodiments of the invention. FIG. 2C is an expanded top view of several optical fibers in the optical fiber ribbon of FIG. 2B.

The marking ink or other indicia 19 includes a series of rows of dots 26 printed on or otherwise applied to the surface of the optical fibers 10. Each dot 26 typically has a size of between 300-400 microns (μm) in diameter. The dots 26 have a distance or pitch 28 with respect to other adjacent dots 26 in their respective row of dots. The dots 26 typically are masses of thermal, solvent or UV curable ink material that can present a certain degree of unevenness or irregularity on or in the surface of the optical fibers 10 and/or the matrix material that bonds the optical fibers 10 together.

According to embodiments of the invention, each row of dots 26 typically contains between 10-50 dots 26. For example, as discussed hereinabove, a relatively wide band of marking ink or other indicia 19 (shown in FIG. 2B as band 21) contains a series of rows of dots 26, with each row of dots having between 5-30 dots 26. Similarly, a narrower band of marking ink or other indicia 19 (shown in FIG. 2B as band 23) contains a series of rows of dots 26, with each row of dots having between 2-10 dots 26. As discussed hereinabove, for identification purposes, a relatively wide band 21 of marking ink or other indicia 19 can represent the number five and a narrower band 23 of marking ink or other indicia 19 can represent the number one. Thus, the optical fiber ribbon 20 shown in FIG. 2B, shown having one relatively wide band 21 and one narrower band 23, can be designated as optical fiber ribbon “6” (1×5+1×1=“6”).

As discussed hereinabove, the application of marking ink or other suitable material on the surface of optical fibers can affect the transmission performance of those optical fibers, as optical fiber transmission loss of a given optical fiber can be relatively sensitive to the marking ink or other suitable material applied to the surface of the respective optical fiber. This is especially true for optical fibers that are part of a rollable or flexible optical fiber ribbon, i.e., an optical fiber ribbon having intermittent matrix bonding material along the length of the optical fiber ribbon. Many current optical fiber cables employ rollable or flexible optical fiber ribbons to achieve a greater packing density within the optical fiber cable.

According to an embodiment of the invention, the spacing or pitch between the dots of marking ink or other indicia 19 applied to the surface of optical fibers 10, e.g., in an optical fiber ribbon 20, affects the optical transmission loss of the optical fibers 10. The optical transmission loss occurs both individually in single optical fibers and collectively in optical fiber ribbons within an optical fiber cable. Also, the optical transmission loss of optical fibers can vary based on the optical transmission wavelength of the optical fibers.

According to an embodiment of the invention, for optical fibers with marking ink or other indicia having a pitch or spacing of between 450 to 500 microns (μm) between the dots of the marking ink or other indicia, optical transmission loss increased compared to optical fibers with marking ink or other indicia having a pitch or spacing of between 620 to 700 μm at an optical transmission wavelength of 1310 nanometers (nm). However, for optical fibers with marking ink or other indicia having a pitch or spacing of between 450 to 500 μm between the dots of the marking ink or other indicia, optical transmission loss did not increase compared to optical fibers with marking ink or other indicia having a pitch or spacing of between 620 to 700 μm at an optical transmission wavelength of 1550 nm.

Also, according to an embodiment of the invention, for optical fibers with marking ink or other indicia having a pitch or spacing of between 540 to 620 μm between the dots of the marking ink or other indicia, optical transmission loss decreased compared to optical fibers with marking ink or other indicia having a pitch or spacing of between 450 to 500 μm at an optical transmission wavelength of 1310 nm. However, for optical fibers with marking ink or other indicia having a pitch or spacing of between 540 to 620 μm between the dots of the marking ink or other indicia, optical transmission loss did not increase compared to optical fibers with marking ink or other indicia having a pitch or spacing of between 450 to 500 μm at an optical transmission wavelength of 1550 nm.

According to an embodiment of the invention, to reduce optical transmission loss and/or prevent additional optical transmission losses at various optical transmission wavelengths, the marking ink or other indicia has a pitch or spacing of between 620 to 700 μm between the dots of the marking ink or other indicia. That is, marking ink or other indicia applied to optical fibers with a pitch or spacing of between 620 to 700 μm between the dots of the marking ink or other indicia avoids added optical transmission loss in the optical fibers at optical transmission wavelengths of 1310 nm, 1550 nm and 1625 nm.

Also, according to embodiments of the invention, it should be understood that the marking ink or other indicia can have a pitch or spacing greater than 700 μm between the dots of the marking ink or other indicia to reduce optical transmission loss and/or prevent additional optical transmission losses at various optical transmission wavelengths. For example, the marking ink or other indicia can have a pitch or spacing of approximately 1,500 μm between the dots of the marking ink or other indicia.

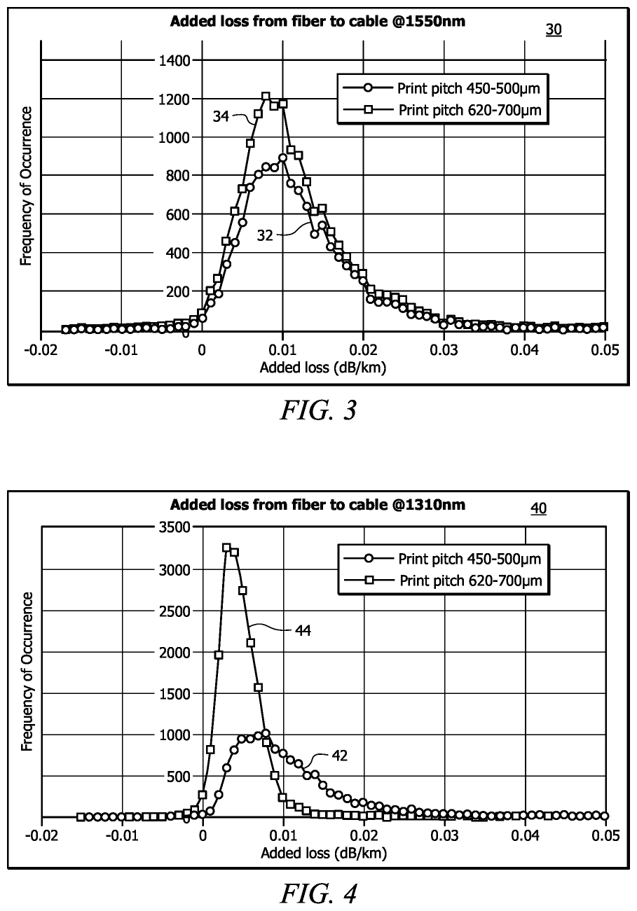

FIG. 3 is a graph 30 of the added optical transmission loss of an optical fiber operating at an optical transmission rate of 1550 nanometers (nm) for different pitches between adjacent print dots, according to embodiments of the invention. The added optical transmission loss shown in the graph to an optical fiber is measured with the optical fiber being included in an optical fiber cable, e.g., as part of an optical fiber ribbon positioned within an optical fiber cable. Optical fibers tend to exhibit greater optical transmission loss when the optical fibers are positioned within an optical fiber cable, e.g., due to stresses placed on the optical fibers when positioned in an optical fiber cable. Thus, added optical transmission loss is the difference between the transmission loss of an optical fiber measured after positioning the optical fiber within an optical fiber cable and the transmission loss of an optical fiber measured before positioning the optical fiber within the optical fiber cable.

The graph 30 shows the frequency of occurrence (y-axis) of added loss (x-axis) in decibels per kilometer (dB/km) for optical fibers with marking ink or other indicia having a pitch or spacing of between 450 to 500 μm between the dots of the marking ink or other indicia (shown as 32). The graph 30 also shows the frequency of occurrence (y-axis) of added loss (x-axis) in decibels per kilometer (dB/km) for optical fibers with marking ink or other indicia having a pitch or spacing of between 620 to 700 μm between the dots of the marking ink or other indicia (shown as 34).

As shown in FIG. 3, the frequency of occurrences of various added loss (e.g., 0.00 to 0.05 dB/km) is roughly the same for optical fibers with marking ink or other indicia having a pitch or spacing of between 450 to 500 μm between the dots of the marking ink or other indicia (shown as 32) as it is for optical fibers with marking ink or other indicia having a pitch or spacing of between 620 to 700 μm between the dots of the marking ink or other indicia (shown as 34).

FIG. 4 is a graph 40 of the added optical transmission loss of an optical fiber operating at an optical transmission rate of 1310 nanometers (nm) for different pitches between adjacent print dots, according to embodiments of the invention. The added loss shown in the graph to an optical fiber is measured with the optical fiber being included in an optical fiber cable, e.g., as part of an optical fiber ribbon positioned within an optical fiber cable. As discussed hereinabove, optical fibers tend to exhibit greater optical transmission loss when the optical fibers are positioned within an optical fiber cable, e.g., due to stresses placed on the optical fibers when positioned in an optical fiber cable.

The graph 40 shows the frequency of occurrence (y-axis) of added loss (x-axis) in decibels per kilometer (dB/km) for optical fibers with marking ink or other indicia having a pitch or spacing of between 450 to 500 μm between the dots of the marking ink or other indicia (shown as 42). The graph 40 also shows the frequency of occurrence (y-axis) of added loss (x-axis) in decibels per kilometer (dB/km) for optical fibers with marking ink or other indicia having a pitch or spacing of between 620 to 700 μm between the dots of the marking ink or other indicia (shown as 44).

As shown in FIG. 4, the frequency of occurrences of lower added loss (e.g., 0.00 to 0.01 dB/km) for optical fibers with marking ink or other indicia having a pitch or spacing of between 620 to 700 μm between the dots of the marking ink or other indicia (shown as 44) tends to be greater than that for optical fibers with marking ink or other indicia having a pitch or spacing of between 450 to 500 μm between the dots of the marking ink or other indicia (shown as 42). Also, the frequency of occurrences of higher added loss (e.g., 0.01 to 0.03 dB/km) for optical fibers with marking ink or other indicia having a pitch or spacing of between 450 to 500 μm between the dots of the marking ink or other indicia (shown as 42) tends to be greater than that for optical fibers with marking ink or other indicia having a pitch or spacing of between 620 to 700 μm between the dots of the marking ink or other indicia (shown as 44). Therefore, the overall added loss for optical fibers with marking ink or other indicia having a pitch or spacing of between 620 to 700 μm between the dots of the marking ink or other indicia generally is lower than for optical fibers with marking ink or other indicia having a pitch or spacing of between 450 to 500 μm between the dots of the marking ink or other indicia.

Therefore, as discussed hereinabove, according to an embodiment of the invention, to reduce optical transmission loss and/or prevent additional optical transmission losses at various optical transmission wavelengths, the marking ink or other indicia has a pitch or spacing of between 620 to 700 μm between the dots of the marking ink or other indicia. That is, marking ink or other indicia applied to optical fibers with a pitch or spacing of between 620 to 700 μm between the dots of the marking ink or other indicia avoids added optical transmission loss in the optical fibers at optical transmission wavelengths of 1310 nm, 1550 nm and 1625 nm.

It will be apparent to those skilled in the art that many changes and substitutions can be made to the embodiments of the invention herein described without departing from the spirit and scope of the invention as defined by the appended claims and their full scope of equivalents.

1. An optical fiber ribbon, comprising:
a plurality of optical fibers arranged adjacent to one another in a linear array;
a bonding matrix material applied to at least a portion of the outer surface of at least two adjacent optical fibers; and
at least one marking applied to the outer surface of at least one optical fiber,
wherein the at least one marking is applied to the outer surface of at least one optical fiber in a manner that reduces the optical transmission loss of the optical fibers.

2. The optical fiber ribbon as recited in claim 1, wherein the at least one marking comprises a series of rows of dots, and wherein at least one of the dots has a distance or pitch with respect to at least one dot adjacent thereto in the same row of dots.

3. The optical fiber ribbon as recited in claim 2, wherein the distance or pitch of the dots is between 450 microns and 500 microns for an optical transmission wavelength of approximately 1550 nanometers and for an optical transmission wavelength of approximately 1625 nanometers.

4. The optical fiber ribbon as recited in claim 2, wherein the distance or pitch of the dots is between 540 microns and 620 microns for an optical transmission wavelength of approximately 1310 nanometers.

5. The optical fiber ribbon as recited in claim 2, wherein the distance or pitch of the dots is between 620 microns and 700 microns for optical transmission wavelengths of approximately 1310 nanometers, 1550 nanometers and 1625 nanometers.

6. The optical fiber ribbon as recited in claim 2, wherein the dots are masses of thermal, solvent or UV curable ink material, and wherein each dot has a size of between 300-400 microns (μm) in diameter.

7. The optical fiber ribbon as recited in claim 1, wherein the distance or pitch of the dots is greater than 700 microns for optical transmission wavelengths of approximately 1310 nanometers, 1550 nanometers and 1625 nanometers.

8. The optical fiber ribbon as recited in claim 1, wherein the at least one marking comprises at least one band that represents a number.

9. The optical fiber ribbon as recited in claim 1, wherein the optical fiber ribbon is a rollable optical fiber ribbon, and wherein the bonding matrix material comprises a plurality of bonding matrix material portions applied intermittently to at least a portion of the outer surface of at least two adjacent optical fibers.

10. An optical fiber, comprising:
a core portion;
a cladding portion formed around the core portion;
at least one coating portion formed around the cladding portion;
at least one marking applied to the outer surface of the at least one coating portion,
wherein the at least one marking is applied to the outer surface of the at least one coating portion in a manner that reduces the optical transmission loss of the optical fibers.

11. The optical fiber as recited in claim 10, wherein the at least one marking comprises a series of dots, and wherein at least one of the dots has a distance or pitch with respect to at least one dot adjacent thereto in the same row of dots.

12. The optical fiber as recited in claim 11, wherein the distance or pitch of the dots is between 450 micros and 500 microns for an optical transmission wavelength of approximately 1550 nanometers and for an optical transmission wavelength of approximately 1625 nanometers.

13. The optical fiber as recited in claim 11, wherein the distance or pitch of the dots is between 540 microns and 620 microns for an optical transmission wavelength of approximately 1310 nanometers.

14. The optical fiber as recited in claim 11, wherein the distance or pitch of the dots is between 620 microns and 700 microns for optical transmission wavelengths of approximately 1310 nanometers, 1550 nanometers and 1625 nanometers.

15. The optical fiber as recited in claim 11, wherein the dots are masses of thermal, solvent or UV curable ink material, and wherein each dot has a size of between 300-400 microns (μm) in diameter.

16. The optical fiber as recited in claim 10, wherein the distance or pitch of the dots is greater than 700 microns for optical transmission wavelengths of approximately 1310 nanometers, 1550 nanometers and 1625 nanometers.

17. The optical fiber as recited in claim 10, wherein the at least one marking comprises at least one band that represents a number.
